(19) United States
(12) Patent Application Publication
(10) Pub. No.: US 2026/0095852 A1
(43) Pub. Date: Apr. 2, 2026

(54) METHODS, ARCHITECTURES, APPARATUSES AND SYSTEMS FOR SCHEDULER REPORTING IN ENERGY SAVING NETWORKS

(71) Applicant: InterDigital Patent Holdings, Inc., Wilmington, DE (US)

(72) Inventors: Faris Alfarhan, Montreal (CA); Oumer Teyeb, Montreal (CA); Paul Marinier, Brossard (CA); Jaya Rao, Montreal (CA); Ananth Kini, Conshohocken, PA (US); Umer Salim, Vallauris (FR)

(21) Appl. No.: 18/902,321

(22) Filed: Sep. 30, 2024

(51) Int. Cl. H04W 52/02

(52) U.S. Cl. CPC H04W 52/0203

(57) ABSTRACT

Procedures, methods, architectures, apparatuses, systems, devices, and computer program products for reporting (e.g., buffer status reporting or power headroom reporting) in energy saving networks are described. One method may include receiving cell configuration information indicating a first cell group and a second cell group, determining that at least the first cell group is in an active network energy saving (NES) state, receiving reporting configuration information associated with WTRU status reporting during a NES state, applying the reporting configuration information associated with WTRU status reporting during the NES state for the first cell group that is in the active network energy saving state. If the first cell group that is in the active NES state will be transitioning from the active NES state to a non-active or non-NES state, the method may include triggering a medium access control (MAC) control element (CE) transmission associated with WTRU status reporting.

### FIELD

Example embodiments described in the present disclosure are generally directed to the fields of communications, software and encoding, including, for example, to methods, architectures, apparatuses, systems related to scheduler reporting in energy saving networks.

### BACKGROUND

Network energy savings relates to enhancements that enable the network to minimize its power consumption from transmission and/or reception. Such minimization of power consumption can be beneficial for reducing operational costs and for environmental sustainability.

### SUMMARY

Some embodiments may be directed to a method, which may be implemented by a wireless transmit/receive unit (WTRU). The WTRU may include circuitry, such as a processor, memory, transmitter and/or receiver. The method may include receiving cell configuration information indicating a first cell group and a second cell group, wherein at least one of the first cell group and the second cell group are capable of applying one or more network energy saving techniques; determining that at least the first cell group is in an active network energy saving state; receiving reporting configuration information associated with WTRU status reporting during a network energy saving state; applying the reporting configuration information associated with WTRU status reporting during the network energy saving state for the first cell group that is in the active network energy saving state; and on condition that the first cell group that is in the active network energy saving state will be transitioning from the active network energy saving state to a non-active network energy saving state, triggering a medium access control (MAC) control element (CE) transmission associated with WTRU status reporting.

In some embodiments, the WTRU status reporting may include any of power headroom reporting and buffer status reporting.

In some embodiments, applying the reporting configuration information associated with WTRU status reporting comprises may include triggering and/or transmitting any of a power headroom report and buffer status report, according to the reporting configuration information, based on the network energy saving state of the first cell group.

In some embodiments, the method may include transmitting the buffer status report, based on the first cell group that is in the active network energy saving state transitioning from the active network energy saving state to the non-active network energy saving state.

In some embodiments, the method may include transmitting, to the second cell group that is not in an active network energy saving state, a combined buffer status report for at least the first cell group that is in the active network energy saving state.

In some embodiments, the method may include triggering a new power headroom reporting, on condition that a power headroom associated with the first cell group that is in the active network energy saving state is above a first configured threshold and a power headroom associated with the second cell group that is not in active network energy saving state is below a second configured threshold.

In some embodiments, the triggered MAC CE transmission may include any one or more of: a buffer status reporting MAC CE transmission, a scheduling request, and/or a power headroom reporting MAC CE transmission.

In some embodiments, the reporting configuration information may include or indicate any of: a pathloss threshold for triggering power headroom reporting, a prohibit timer for medium access control (MAC) control element (CE) transmission, and a periodic timer for triggering the medium access control (MAC) control element (CE) transmission.

In some embodiments, the network energy saving state may include or relate to any of cell discontinuous reception (DRX), cell discontinuous transmission (DTX), or the non-active period associated with cell DTX, or other network energy saving state.

In some embodiments, the network energy saving state is activated on the first cell group if or when any one or more of: a base station (e.g. at least one base station) associated with the first cell group is in the network energy saving state, all cells in the first cell group are in the network energy saving state, and a primary cell in the first cell group is in the network energy saving state.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example flow diagram of a method, according to some emobidments;

FIG. 3 illustrates an example flow diagram of a method, according to some emobidments; and

FIG. 4 illustrates an example flow diagram of a method, according to some emobidments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

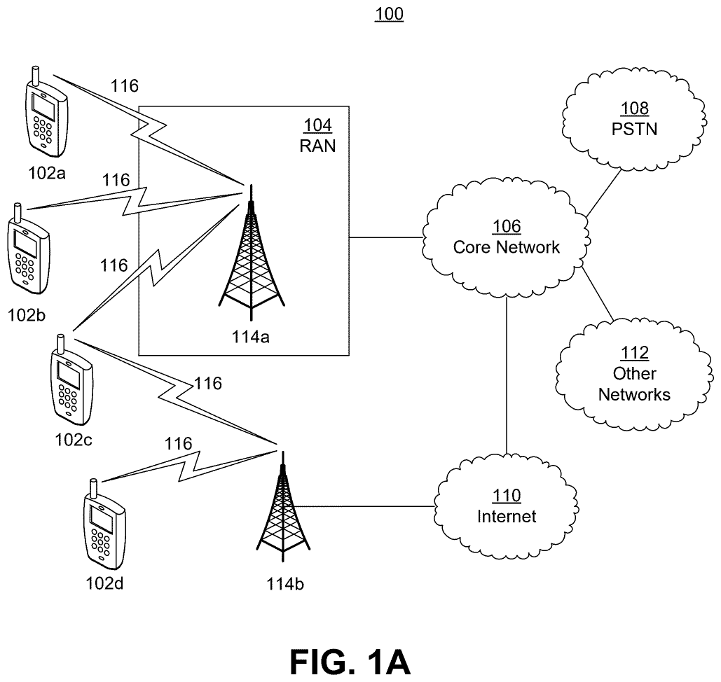

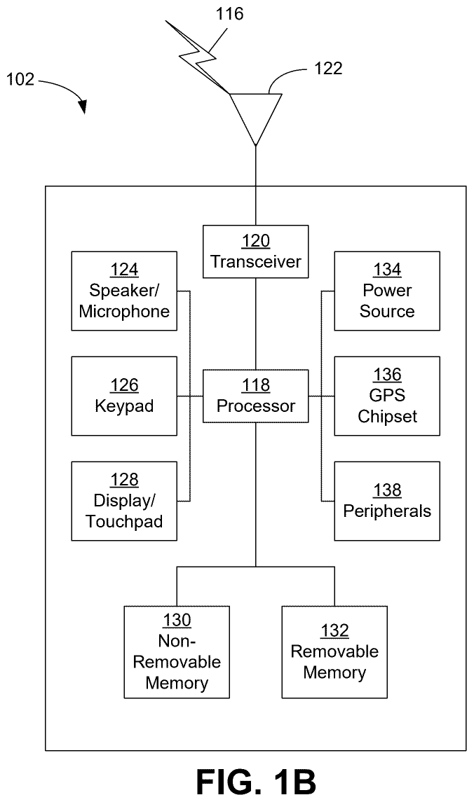

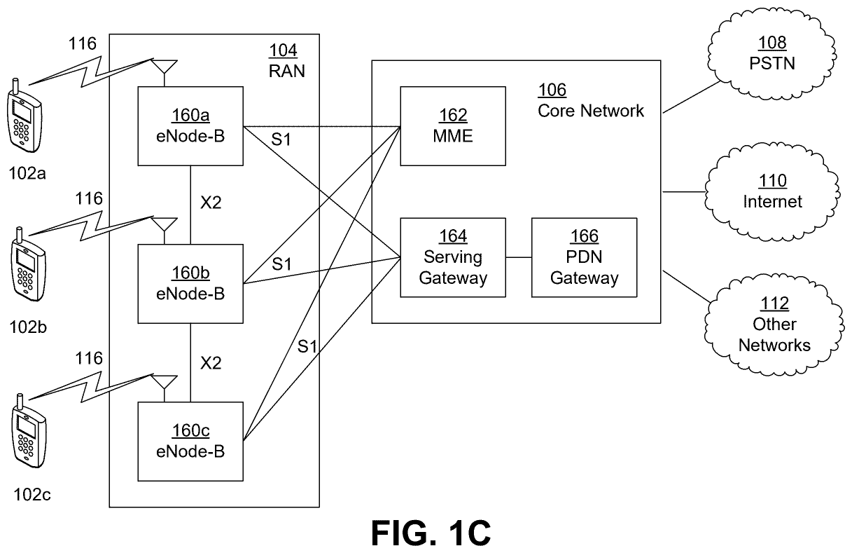

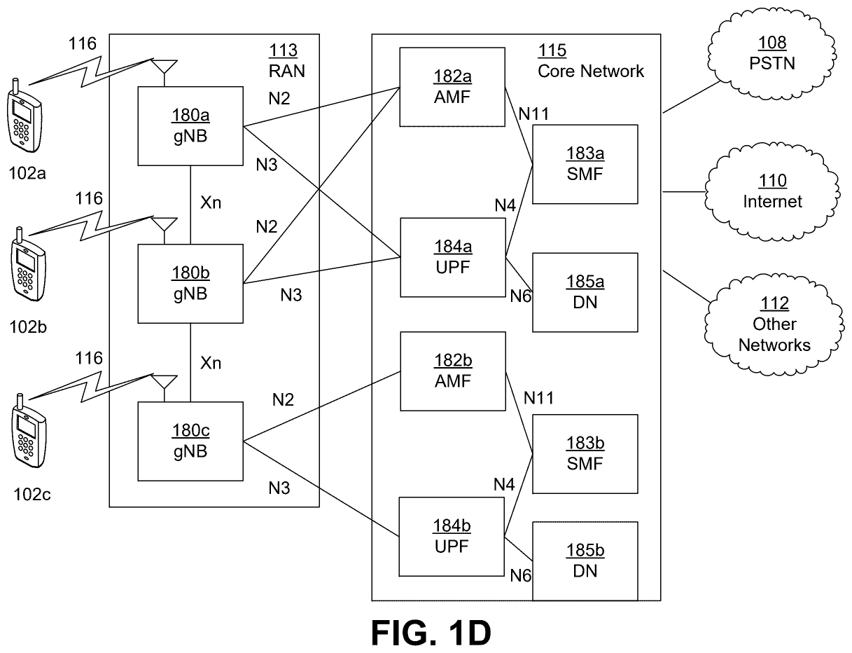

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Example embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “base station”, “seving base station”, “RAN,” “RAN node,” “Access Network,” “NG-RAN,” “gNodeB,” and/or “gNB” may be used interchangeably to designate any network element such as, e.g., a network element acting as a serving base station. It should be understood that embodiments described herein are not limited to gNBs and are applicable to any other types of base stations.

It is further noted that, as used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

Network energy savings for 3GPP Rel-18 is being studied to produce enhancements enabling the network to minimize its power consumption from transmission and reception. Such minimization can be beneficial for reducing operational costs and environmental sustainability.

Compared to earlier systems, the design of NR of Rel-15 is very efficient from the perspective of minimizing transmissions from the network when there is no data. For example, always-on cell-specific reference signal (CRS) is not used in NR. However, there is still potential for energy consumption reduction.

NR cell discontinuous transmission/discontinuous reception (DTX/DRX) mechanisms are designed to manage the downlink transmission and uplink reception activities of a network node (e.g., gNB) and WTRUs or UEs. Traditionally, C-DRX is configured per WTRU or UE, and DRX cycles or offsets are aligned via radio resource control (RRC). During the UE DRX off period, the WTRU or UE does not monitor the physical downlink control channel (PDCCH) but can initiate UL transmission using predefined resources. Cell DTX/DRX aims to inform WTRUs or UEs about cell inactivity, potentially enhancing UE DRX configurations for better alignment of DRX cycles or start offsets, leading to prolonged cell inactivity. In Cell DTX/DRX periods, the cell may limit its transmissions to reduce activity, omitting certain periodic signals or channels. During non-active periods, the WTRU or UE does not transmit scheduling request (SR) or configured grant physical uplink shared channel (CG-PUSCH) and the WTRU or UE does not monitor select channel state information (CSI)-reference signal (RS) and semi-persistent scheduling (SPS)-physical downlink shared channel (PDSCH) transmissions.

The configuration of Cell DTX/DRX involves specifying periodicity, start slots/offsets, and on-duration, which can be managed separately for DL and UL or jointly. These configurations are usually applied to WTRUs or UEs in the RRC_CONNECTED state and can be activated or deactivated dynamically via group common L1 downlink control information (DCI) signalling and RRC signalling. WTRUs or UEs can handle multiple cell DRX/DTX configurations for different serving cells simultaneously, with the ability to switch between configurations based on network signaling. Active periods refer to when the configured DTX/DRX patterns are operational and the cell DTRX on duration timer is running, while inactive periods are when they are not, allowing UEs to manage their monitoring and transmission activities efficiently during these times.

The network may also dynamically turn off some cells all together to save energy. Prior to such an event, the network may send a conditional handover (CHO) indication to allow remaining WTRUs or UEs to handover to other cells.

For a multi-connectivity bearer, the WTRU or UE maintains a layer 2 (L2) protocol stack per serving cell group. In NR and LTE, such splitting of the protocol stack is in the Packet Data Convergence Protocol (PDCP) layer. In Dual connectivity, master cell group (MCG) bearer data only goes on the master node (MN) leg. Secondary cell group (SCG) bearer data only goes on the secondary node (SN) leg. SRB data is only routed towards the primary cell group (unless duplicated).

For split bearers or for RBs configured with PDCP duplication, each PDCP entity is associated with two UM RLC entities for delivering the duplicates. If the PDCP duplication is activated, duplicate the PDCP Data PDUs are submitted to both RLC entities. For split bearers, if the total amount of data volume pending for initial transmission in the two associated RLC entities is equal to or larger than a threshold (e.g., ul-DataSplitThreshold), the WTRU or UE submits the PDCP PDU to either the primary RLC entity or the secondary RLC entity; else (data volume is lower than the threshold), the WTRU or UE submits the PDU to the configured primary RLC entity.

With multi-connectivity configured in connected mode, the WTRU or UE reports buffered data for each cell group separately in DC, e.g., periodically. For power headroom reporting (PHR), the WTRU or UE maintains separate power headrooms (PHs) for the MN and SN because these nodes can operate independent schedulers and require information on the available power headroom for uplink scheduling. PHR is reported periodically or triggered if the pathloss changes on either leg by more than a delta. Type2 PHR is capable of reporting PH for both MN and SN. Once PHR is triggered, the WTRU or UE sends the PHR MAC CEs to both the MN and SN gNBs, respectively.

The existing data plane does not work practically well for networks using network energy saving methods (e.g. cell DTX, dynamic power off/on, which can be signalled dynamically), particularly in dual-connectivity (DC) and/or multi-connectivity (MC) scenarios where there is more than one serving cell group. In particular, certain issues may exist with respect to the transmission of reporting medium access control (MAC) control elements (CEs), such as buffer status report(s) and/or power headroom report(s), in DC with network energy saving (NES).

For BSR, the WTRU reports buffered data for each cell group separately in DC, e.g. periodically. For split bearer, if the data volume is larger than the threshold, the WTRU reports it for both MAC entities. However, if the threshold is set to infinity, BSR MAC CE is never reported to a secondary node (SN) or cell group even during the cell DRX active period. Hence, an issue arises as to how to avoid unnecessary reporting (e.g., to a sleeping node or a node in a NES state), for example, when the reported buffer status will be outdated, stale, or not used by the node in NES state.

For PHR in DC, the WTRU maintains separate PHRs for the master node (MN) and SN because these nodes can operate independently and require information on the available power headroom for uplink scheduling. The current framework thus results in having the WTRU report PHR MAC CEs to a sleeping gNB, and by the time the MAC CE is received, it may not be useful for the scheduler as the channel conditions have changed; it might also not be used by a scheduler of a sleeping node. The periodicity of the PHR reporting may also trigger numerous PHRs that aren't needed by a sleeping gNB, as a common periodicity is used for all PHR reports.

As will be discussed in more detail below, some embodiments may provide at least scheduling support for multi-connectivity with dynamic NES state activation/deactivation. For example, certain embodiments may include methods for PHR, BSR, and/or SR triggering and multiplexing rules. For example, an embodiment may provide new triggers to transmit BSR and/or PHR when a cell is waking up (e.g., when a cell is moving or transitioning from a NES state to non-NES state). As a further example, some embodiments may provide information that can also be used by the network to wake-up a cell (e.g., to determine to wake-up from an active NES state) or perform some other action.

As used herein, channel conditions may refer to any conditions relating to the state of the radio/channel, which may be determined, by the WTRU, from a WTRU measurement (e.g., L1/SINR/RSRP, CQI/MCS, channel occupancy, RSSI, power headroom, exposure headroom), L3/mobility-based measurements (e.g. RSRP, RSRQ, s-measure), an radio link monitoring (RLM) state, and/or channel availability in unlicensed spectrum (e.g., whether the channel is occupied based on determination of an LBT procedure or whether the channel is deemed to have experienced a consistent LBT failure).

As used herein, a PRACH resource may refer to a PRACH resource (e.g., in frequency), a PRACH occasion (RO) (e.g., in time), a preamble format (e.g., in terms of total preamble duration, sequence length, guard time duration and/or in terms of length of cyclic prefix) and/or a certain preamble sequence used for the transmission of a preamble in a random-access procedure.

As used herein, uplink control information (UCI) may include or may refer to CSI, HARQ feedback for one or more HARQ processes, Scheduling request (SR), Link recovery request (LRR), CG-UCI and/or other control information bits that may be transmitted on the PUCCH or PUSCH.

A property of scheduling information (e.g., an uplink grant or a downlink assignment) may include at least one of the following: a frequency allocation; an aspect of time allocation, such as time instance or/and a time duration; a priority; a modulation and coding scheme; a transport block size; a number of spatial layers; a number of transport blocks to be carried; a TCI state or SRI; a number of repetitions; whether the grant is a configured grant type 1 (i.e., WTRU immediately using the configured UL resources after receiving the configuration information), type 2 (i.e., WTRU waiting until an explicit MAC CE indication before using the configured UL resources) or a dynamic grant.

An indication, such as by DCI, may include at least one of the following: an explicit indication by a DCI field or by RNTI used to mask CRC of the PDCCH; an implicit indication by a property, such as DCI format, DCI size, Coreset or search space, aggregation level, identity of first control channel resource (e.g., index of first CCE) for a DCI, where the mapping between the property and the value may be signaled by RRC or MAC; an explicit indication by a DL MAC CE.

Herein, a NES state or an availability state may refer to a cell state in which the network node, cell or TRP has activated at least one NES technique. An NES technique may include any of: reduced SIB1 transmission (periodic or existence), reduced SSB transmission (periodic or existence), cell DTX, cell DRX, spatial domain adaptation (where a subset of antenna ports and/or elements are turned off), power domain adaptation (where a subset of channels are transmitted with reduced power or muted), the cell or TRP has turned off, and/or the like.

A WTRU may determine whether it can transmit or receive on certain resources depending on a network availability state. A network availabitliy state may imply or include for example the network's (e.g., the gNB's) power savings status, a network energy savings (NES) state, a cell DTX mode, a cell DRX mode, and/or a gNB activity level. An availability state can be uplink or downlink specific, and may change from symbol to symbol, slot to slot, frame to frame, or on a longer duration granularity. The availability state may be determined by the WTRU or indicated by the network (NW). An availability state can be, for example, “On”, “DL and UL active”, “UL only active”, “off”, “reduced Tx power”, “dormant”, “sleep (de)-activated”, “micro sleep”, “light sleep”, “deep sleep”, the active period of a sleep pattern, and/or the deactive period of a sleep pattern.

In a sleep pattern, the active period may correspond to the time when the NW may actively transmit DL signals/channels and/or the time when the NW may blind decode for UL signals/channels. Such states can be abstracted by NW configuration parameters and/or values, and dynamic indication may point to the active availability state (e.g., by DCI or MAC CE signaling). The “Off” availability state or the non-active period of sleep pattern may imply that the gNB's baseband hardware is completely turned off. The “sleep” availability state may imply that the gNB wakes up periodically to transmit certain signals (e.g. presence signals, synchronization, or reference signals) or receive certain UL signals. In some availability states, some DL or UL resources are not available during certain periods of time, and this enables the network to turn off baseband processing and other activities. For example, the WTRU may be configured by RRC with periodic Active and Inactive periods per availability. Some measurement resources (e.g. SSBs or CSI-RS) may only be made available in certain availability states, including: RLM, BFD, RRM measurements, CSI-RS feedback configuration, and/or a different power offset for CSI feedback.

Under certain conditions, the WTRU may further transmit a request to the network (wake-up request) to modify the availability state to a state for which resources that would satisfy WTRU requirements are available. The WTRU can determine an availability state from reception of availability state indication from, e.g., by L1/L2 signalling (e.g., a group common DCI or indication), or implicitly determine it form the reception of periodic DL signalling or lack thereof.

The WTRU may determine if a resource is available for transmission/reception and/or measurements for the determined network availability state if it is applicable in the active availability state. In addition, the WTRU may also adapt its active C-DRX cycle, active spatial elements (e.g., antenna or logical ports), active TRPs, paging occasions as a function of the signalled or determined availability state. The WTRU may be configured with one or more sets of NES transmission and/or reception parameters per availability state, e.g., by broadcast or dedicated configuration signalling. The WTRU may apply the NES parameter set according to the determined or signaled availability state. The WTRU may apply one or more applicable configurations depending on the determined NES state. A set of NES parameter may include: a number of antenna ports, a C-DRX configuration, a measurement configuration (e.g. for RRM, RLM, and/or BFD), CSI feedback, a CSI-RS configuration, an SSB configuration, CHO or mobility candidates, and/or a set of active TRPs.

An availability state may be applicable to at least one transmission, reception, or measurement resource. An availability state may be applicable to at least one time period such as a time slot or time symbol. An availability state may be applicable to a serving cell, a cell group, a frequency band, a bandwidth part, a TRP, a set of spatial elements, or a range of frequencies within a bandwidth part. For example, when an NES state changes in a cell, the WTRU may receive an availability state change indication indicating that this change is just for that cell, for all cells at the same frequency, and/or same RAT.

The WTRU may consider the active availability state associated with a cell, carrier, TRP, or frequency band to be “Off”, “Deep sleep”, or “Micro sleep” after reception of a DL signaling that changes the cell's or TRP's availability state. For example, the WTRU may receive a turn off command on broadcast signaling, RRC signaling, DCI (e.g. a group common DCI), or a DL MAC CE (e.g. indication part of PDSCH). The WTRU may determine an availability state from reception of availability state indication from, e.g., L1/L2 signalling (e.g. a group common DCI or indication) or broadcast signalling associated with an availability state.

For example, an availability state change indication could also be part of SI update or SIB signalling (e.g., in a separate SIB that is not read by legacy UEs). There can be a common time for the WTRUs (e.g., all WTRUs) in the cell to determine availability state status.

For example, the WTRU may determine a change of NES state change from the reception of a group common command L1 signaling (e.g., a group common DCI, a multi-stage DCI, a specific DCI format, or a DCI scrambled by a configured or specified NES-specific RNTI). L1 signaling may indicate one of the configured NES parameters sets to apply or may determine a delta configuration from the current set of parameters upon determining an NES state change. The WTRU may transmit feedback/acknowledgment to the network (e.g., node or gNB), possibly multiplexed with UL data (e.g., part of an UL TB as a MAC CE or a subheader indication), following the reception of NES state change indication.

For example, the WTRU may determine a change of NES state change from the reception of broadcast signaling associated with NES state indication or change, including signaling in SIB(s) or part of a broadcast or multicast PDSCH. The WTRU may be indicated the NES state explicitly in the SIB. The WTRU may be configured with one or more SIBs exclusively associated with configuration of NES parameters. The WTRU may be configured to receive such broadcast or multicast indication periodically; the WTRU may determine an indication is mis-detected if not received on expected periodic occasions, if a number of misdetections is counted, and/or if a timer has elapsed since the last reception of the NES state indication. The WTRU may start inter-cell, inter-frequency, and/or inter-RAT measurements, start a mobility procedure, and/or start evaluating configured CHO candidates following the determination of a misdetection of the NES state indication.

In some examples, the WTRU may implicitly assume a certain availability state associated with a cell, carrier, TRP, or frequency band (e.g., “Off, ”deep sleep“, ”micro sleep“ or dormant”) from at least one of the following: reception of a command or signal indicating a change in availability state (e.g., a group common DCI in connected mode or RRC signaling or a presence signal. The WTRU may determine an availability state implicitly form the reception of periodic DL signaling. The WTRU may be configured or specified to associate an availability state with one or more DL signal type (e.g., SSB, partial SSB, and/or one or more periodicity)); reception of a paging message, paging DCI, paging PDSCH, or a paging related signal or PEI (e.g., possibly on a subset of POs (e.g., those aligned with NES drx cycle or a configured subset of PDCCH resources). The WTRU may assume a certain availability state after reception of an indication part of the DCI or PDCCH scheduling paging (e.g., as a function of the P-RNTI, NES-RNTI or based on receiving an explicit indication, e.g., on a reserved bit). The WTRU may assume a certain availability state after the reception of a paging message with a certain P-RNTI, a separately configured NES P-RNTI, or the NES group RNTI. The WTRU may assume a certain availability state after the reception of a paging message with a certain P-RNTI.

The WTRU may be configured with one more PEI subgroup for NES, where a subgroup may be associated with one or more availability states. The WTRU may assume a certain availability state after reception of a PEI with an NES subgroup, possibly if that subgroup is configured and/or associated with the availability state. The indication of the availability state or the availability state switch may be indicated in the paging payload, e.g., as a flag part of the paging message or the short message. Such paging indication may further indicate an alternative cell to monitor paging on while the cell from which the signaling was received is off, sleep, or in NES state. Such paging indication may further indicate or signal applicable reconfiguration parameters (e.g., for initial access, applicable PRACH resources, applicable SSB/RS occasions, applicable SI cycle, and/or the applicable cell(s) and associated availability states); reception of a paging message, paging DCI, paging PDSCH, or a paging related signal (e.g., PEI); the gNB DTX status (whether the gNB is in active time or an associated activity timer is running); lack of detection of a presence indication (e.g., WTRU may determine an availability state associated with the cell, e.g., “off” or “deep sleep”), e.g., if presence indication was not detected on one or more presence indication occasions.

The WTRU may assume or change the cell's availability state after a number of consecutive misdetections or after timer expires following no detection of a presence signal. The WTRU may determine an availability state is active or de-active after expiry of a timer associated with the availability state. Such timer can be configured and/or maintained in connected mode only, or also in other states (e.g., idle and inactive states). The WTRU may determine an availability state implicitly form the lack of reception of periodic DL signaling. For example, the WTRU may be configured with a signal quality threshold (e.g., an RSRP threshold) and if the WTRU does not detect a signal associated with an availability state (e.g., a presence signal or an SSB) with a signal strength above the threshold, the WTRU may assume that this availability state is not active and may assume a different availability state. This criterion can be also coupled with lack of detection of an identifying sequence of the presence signal (e.g., detection of the PSS sequence for example); based on time in the day, e.g., WTRU may be configured to automatically assume a certain availability state (e.g., off, sleep, or dormant) for a configured subset of cells (e.g., capacity boosting cells) depending the time in the day. For example, the WTRU may determine that a capacity boosting cell has an availability state as “On” in certain hours of the day, “Deep sleep” in other configured hours, and “Off” in a third set of configured hours of the day or night); based on the availability state of an associated cell (e.g. another carrier of the same MAC entity, another carrier in the same cell group, another carrier in the same gNB, another sector in the same gNB, or a configured associated cell or capacity boosting cell); based on detection of a PSS only signal or a simplified/stripped down SSB signal; based on detection of an RS signal (e.g., CSI-RS, PRS, TRS) or the lack thereof; the WTRU's RRC state (idle, inactive, or connected mode); whether paging has been received, possibly within a configured time window; whether system information (e.g. periodic SI or a subset of SIBs) have been received, possibly within a configured time window; measured channel condition(s) being below or above a threshold (e.g., the WTRU may assume a change of NES state based on a change of measured channel conditions or making a channel measurement below or above a threshold. For example, the WTRU may use degradation in measurements of SSBs or CSI-RS, possibly in combination with other signaling to determine the NES state. For example, a configured window following the DCI reception can be used to measure SSBs and/or CSI-RS for degradation, and if a delta of SSB-RSRP drop is measured the WTRU may determine that the NES state has changed and assume associated actions for such NES state (e.g., trigger for CHO candidate selection or for group scheduling for a mobility command).

The WTRU may be configured to monitor an indication that may characterize the level of network activity (e.g., an availability state). The network activity may be associated with a base station, gNB, a cell and/or a TRP. The WTRU may assume the same availability state for all cells part of the same base station, TRP or gNB, e.g., cells of the same MAC entity. The network activity indication (e.g., the presence indication) may include a channel (e.g., a PDCCH) and/or a signal (e.g., a sequence). The activity indication or the NES state change indication/command may indicate the level of activity the WTRU may expect from the associated base station, TRP, gNB and/or cell, e.g., reduced activity. The activity indication may contain activity information of other base stations, gNBs and/or cells. The activity indication may be a PDCCH containing group common signaling. For example, the NW may transmit a group common DCI to a group of WTRUs (e.g., WTRUs in the serving cell) indicating a change of an activity state or activity level in UL and/or DL. The CRC of the PDCCH may be scrambled with a dedicated “activity indication RNTI or an NES-RNTI.” A WTRU may be configured with at least one search space associated with the monitoring occasions of the activity indication PDCCH. The indication may include a go-to-sleep signal, e.g., a predefined sequence. When a WTRU detects this sequence, the WTRU may expect a reduced activity level over a specific time duration. The WTRU may activate C-DRX for the period of time indicated. Alternatively, two sequences may be used to indicate regular activity and reduced activity.

For example, the signaling within the PDCCH or the activity indication may contain at least one of the following: expected activity level of the associated base stations/gNBs/cells over a specific time interval (e.g., an availability state). The activity levels may be predetermined and/or configured and may, for example, include regular and reduced activity. The signaling may indicate the activity level. For example, bit “1” may indicate regular activity and bit “0” may indicate reduced activity; for each activity level (e.g., availability state) transmission and reception attributes may be defined (for example, during reduced activity, WTRU may not be expected to monitor certain PDCCH search spaces (including all SSs), and/or receive a certain type of PDSCH (including all PDSCH), and/or transmit PUCCH/PUSCH, and/or perform certain measurements. The WTRU may start or stop monitoring PDCCH and/or TCI states associated with determined NES state, including PDCCH resources or TCI states associated with (de-)activated TRPs or spatial elements; a set of configurations may be associated with an activity level and may be used/applied when that activity level is indicated (e.g., an NES parameter set). For example, SS configurations, CSI reporting configurations, indices of transmitted SSBs, etc. Each set of configurations may have an attribute associated with an activity level. For example, a tag that can be set to “reduced activity”; the time interval over which an activity level is assumed may be signaled in the PDCCH or part of the activity indication (e.g., the time interval may be indicated using a bitmap where each bit in the bitmap may be associated with a specific duration, e.g., a slot or a frame. For example, bit “1” may indicate regular activity and bit “0” may indicate reduced activity on an associated frame. The time interval may be indicated with a start time and length of interval. The start time may be defined, for example, it may be determined by adding a fixed offset to the time the indication is received. The length of the interval may be configured or signaled in the indication PDCCH); the time interval over which an activity level is assumed may be predetermined (e.g., the WTRU may assume an interruption delay, or more generally a time till the NES state changes, after the NES state change command reception (e.g., after the last symbol or slot on which the command was received). The interruption time can be in absolute time, a number of symbols, or a number of slots.

The WTRU may determine that an uplink or downlink resource or signal is available for transmission/reception and/or measurements for the determined network availability state if it is applicable in the active availability state. The WTRU may determine that a subset of measurement resources and/or signals (e.g., SSBs, CSI-RS, TRS, PRS) are not applicable in certain availability states. The WTRU may determine that a subset of uplink or downlink resources (e.g., PRACH, PUSCH, PUCCH) are not applicable in certain availability states. The WTRU may transmit some uplink signals only in a subset of NW availability states (e.g., SRS, pSRS, PRACH, UCI).

The terms network NES state and cell NES state may be used herein interchangeably. A WTRU may know the cell NES state for one or more cells, e.g., through network configuration and indication. When used as network NES state, it means the NES states of one or more cells which could be serving cells, neighbor cells, etc. A NES state may imply an activation state only for a NES state, while another NES state may correspond to the deactivation state. The terms network availability state, cell turned off, SIB1-less operation, reduced SIB1/SSB periodicity state, (de)-active cell DTX mode/configuration, or NES state may be used interchangeably. The WTRU may determine a SSB/SIB1 transmission state (whether they are transmitted and/or periodicity) implicitly from a determined active availability state, and vice-versa. Herein, a NES cell may refer to a cell that is applying at least one NES technique, is in a NES state (e.g., activated NES state), and/or is capable or configured to apply an NES technique at some point. Therefore, a non-NES cell may be used to refer to any cell that is not designated as a NES cell per this definition (e.g., not in a NES state or cannot/doesn't apply a NES technique). In one alternative, the designation of which cell that can be NES cells may be configured (e.g., by broadcast or dedicated signaling). One active NES state may correspond to the non-active period of a cell DTX and/or cell DRX pattern that is activated, while another deactivated NES state may correspond to the active period of a cell DTX and/or cell DRX pattern that is activated.

In one or more NES state(s), the WTRU may transmit a wake up signal (e.g., PRACH, SR, PUCCH, UCI on PUCCH, a MAC CE or WTRU assistance information) to request a change in the NES state, additional UL or DL resources, reception of on demand SSB, reception of on demand SIB1/SI, or activation of a given cell (e.g., on that is in a NES state). Triggers for the WTRU to transmit a wake-up signal and/or request reception of an on demand SSB may include any one or more of: detection of a reference signal, making a channel measurement on the cell or an associated cell less than or greater than a threshold, arrival of new data (possibly for a given LCH/LCG), amount of buffered data exceeding a threshold (possibly for a given LCH/LCG), based on positioning being within a given range, based on triggering BSR/SR, based on triggering a L3 mobility events, based on the WTRU or cell DTX/DRX status, based on expiry of a timer, and/or the WTRU receiving request from higher layers to transmit on-demand SSB request, or the like.

As used herein, when referring to a cell group being in a NES state and/or an active NES state, it may refer to one or more of the following: all cells in that cell group are in an active NES state (e.g. off, cell DTX/DRX etc) or using at least one NES technique; there is no cell in the cell group that is not in a NES state or an active NES state; the primary cell in the cell group is in a NES state (for example, “SCG is in NES state” may refer to the fact that the PSCell is in a NES state or an active NES state); the primary cell in the group is in a NES state (e.g. PSCell of an SCG or the PCell of an MCG) and other SCells are in a NES state; at least one cell in the cell group is in a NES state, an active NES state, or using at least one NES technique; a certain percentage (e.g., x %, more than 50%, etc. ,) of the cells in the cell group are in an NES state, an active NES state or using at least one NES technique; and/or the base station (e.g., node or gNB) associated with the cell group is in a NES state (e.g. cell DTX/DRX, off, low power operation etc.). Additionally, it should be understood that a given meaning for “NES state for a cell group” can be applicable for one procedure or context, while a different meaning can be applicable for another procedure or context.

Power headroom reports (PHR) are useful for power-aware packet scheduling. Power headroom is a measure of the difference between the WTRU's nominal maximum transmit power and the estimated power required for uplink transmission. Given the amount of power needed to transmit uplink data at a constant SNR is scaled by the amount of PRBs assigned for uplink transmission, the scheduler typically avoids over-allocating uplink resources for the PUSCH if the WTRU would reach its maximum power. By analyzing power headroom reports, the scheduler can effectively manage power resources while ensuring reliable and efficient communication.

PHR provides information to facilitate efficient power management during transmission. The gNB can infer at least some of the following information from a PHR report: the gap between the WTRU's actual or hypothetical transmit power and the WTRU's maximum power; the maximum power reduction (MPR) reduction implemented by the WTRU for each cell (e.g., this information allows the gNB to learn, over time, the specific MPR reduction taken by the UE for different grant sizes); assessing whether the WTRU has exceeded its maximum power limit on any cell (e.g., the gNB can use such information to determine whether it is feasible to increase or reduce scheduling activities on a particular cell); whether the WTRU has surpassed its overall maximum power limit, leading to scaled channels (e.g., understanding the presence of scaled channels assists the gNB evaluate the combined scheduling across multiple cells); and/or determining the current value of the combination of pathloss and Transmission Power Control (TPC) accumulator terms in the power control equation for each cell (e.g., this enables the gNB to adjust more accurate power control calculations for future scheduling decisions.

PHR reports are transmitted using MAC control elements (CEs) for added reliability. Typically, the WTRU triggers power headroom reporting when it is scheduled to transmit uplink data or about to transmit uplink data. In NR, the WTRU can trigger the reporting of PHR upon satisfying one of the following triggers: when the measured pathloss changes by more than a configured threshold (e.g., a PHR is triggered when the difference between the current power headroom and the last reported power headroom is larger than a configured threshold); upon expiry of a periodic reporting timer; when there is remaining space in the uplink grant, the WTRU adds a padding PHR reporting (e.g., similar to padding BSR); the value of the power backoff value due to power management (P-MPR) applied to meet FR2 maximum permissible exposure (MPE) requirement is above a configured threshold or has changed by more than a configured threshold since the last PHR transmission due MPE P-MPR, which may trigger a “MPE P-MPR PHR” PHR report type; and/or PUCCH resources are available on a carrier and the required power backoff due to power management (as allowed by P-MPR) for this cell has changed more than a configured threshold since the last transmission of a PHR.

Three PHR types of reporting are supported based on different transmission scenarios. Type 1 reports power headroom assuming PUSCH-only transmission on the carrier. It is valid for a single carrier. This PHR type of reporting is used for power control scheduling when transmitting PUSCH data. This PHR type can also be reported when there is no actual PUSCH transmission, as the power headroom is computed assuming a default transmission configuration corresponding to the minimum possible resource assignment.

Type 2 PHR may be similar to type 1, but the transmit power computation includes an assumption that both PUSCH and PUCCH transmissions occur simultaneously. This PHR type is designed for dual connectivity deployment scenarios where both PUSCH and PUCCH transmissions occur within a Cell Group.

Type 3 PHR is designed to aid with SRS switching on SCells configured with SRS only transmission and is reported when the mobile device is transmitting sounding reference signals but no PUSCH or PUCCH. This type of reporting allows the gNB to evaluate the uplink channel quality of alternative SCells and thus instruct the mobile device to activate such carriers for uplink transmission instead, if deemed better.

A MPE P-MPR PHR refers to the power backoff to meet the maximum permissible exposure (MPE) requirements for a serving cell operating on FR2 frequencies.

The power headroom, PH_{c}(t), associated with a particular serving cell “c” during subframe t can be expressed using a formula. In simple form, PH_{c}(t) is obtained by subtracting the transmit power of serving cell c in subframe t, before any adjustments to prevent exceeding the maximum power limit. The calculation is as follows: PH_{c}(t)=Pcmax,c(t)−Transmit power of serving cell c in subframe t (pre-adjustments to not exceed max power).

The value of Pcmax,c(t) represents the actual maximum power per carrier configured for the UE within the serving cell during subframe t. This value is configured by the network and is thus known to the scheduler. This value takes into consideration the permissible MPR allowed by the UE. It is important to note that the MPR value can be equal to or less than the maximum allowed value. The transmit power value used in the formula is not the actual uplink transmit power, but rather the transmit power that would have been used assuming that there is no upper limit on the transmit power cap. The reported PHR can therefore be a negative value, thus indicating to the network that the UE would reach its maximum transmit power on the carrier for a given resource allocation, and thus has the mobile device cannot transmit the scheduled amount of data without power reduction. The scheduler can thus reduce the selected MCS and schedule less PUSCH data to sustain enough energy per bit without having the UE exceed its maximum transmit power.

In carrier aggregation scenarios, a reference power is employed to generate a virtual report when no transmission takes place on an activated SCell. This virtual report assists in maintaining a comprehensive view of the power headroom situation across the network.

As mentioned above, to ensure compliance with the Maximum Permissible Exposure (MPE) exposure regulations for Frequency Range 2 (FR2), which limits RF exposure on the human body, PHR reports may include Power Management Maximum Power Reduction (P-MPR) information. This information is utilized by UE to ensure adherence to the specified MPE requirements.

Uplink buffer status reports (BSR) may be needed to provide support for QoS-aware packet scheduling. In NR, BSR is reported at a logical channel group (LCG) granularity. A WTRU can be configured with up to 32 logical channel IDs (LCID), and these can be grouped into as many as 8 LCGs. It should be noted that some special UEs may be configured with more than 32 LCIDs and more than 8 LCGs (e.g., the mobile termination (MT) of an integrated backhaul access (IAB) node may be configured with up to 65855 LCIDs and 256 LCGs).

A BSR is sent using a MAC CE and can be sent in two formats: a short BSR format to report the data for only one LCG, or a long BSR format to report the data from several LCGs.

BSR reporting from the WTRU plays a role in supporting QoS-aware packet scheduling in 5G NR networks. These reports provide valuable information about the data buffered in logical channel groups (LCGs) within the WTRU. In NR and LTE, four reporting formats are used for transmitting uplink buffer status reports, allowing for flexible and efficient communication of this essential information. The formats include short BSR, flexible long BSR, extended short format BSR, and extended long format BSR. Short BSR format enables the reporting of a single BSR pertaining to one LCG. With the flexible long format, multiple BSRs can be reported, thereby allowing for the transmission of up to all eight LCGs'buffer status. The extended short format is used to report a single BSR of one LCG. The extended long format facilitates the reporting of multiple BSRs, accommodating up to all 256 LCGs. The extended versions of the BSR formats are applicable to Integrated Access and Backhaul (IAB) nodes.

As mentioned above, uplink BSRs may be transmitted using MAC CEs. When a BSR is triggered, typically when new data arrives in the WTRU's transmission buffers, the WTRU triggers the transmission of a Scheduling Request (SR) if no resources are available for transmitting the BSR. This mechanism ensures that the network is aware of the buffer status even when immediate resources for BSR transmission are not available.

For example, a BSR may be triggered or occur based on any one or more of the following events or configurations. Based on new UL data becoming available at the WTRU's buffer (and/or this UL data belongs to a logical channel with higher priority than the priority of any logical channel with available UL data (new data of higher priority) or none of the logical channels contain any available UL data (new data arrival on empty buffer). This BSR type is referred to as ‘Regular BSR’. Based on uplink resources being allocated and there is remaining space in the grant after applying LCP and filling the grant with data. The number of padding bits must fit within the size of the BSR MAC CE. This BSR type is referred to as ‘Padding BSR’. Retransmission BSR of a BSR that has not been yet acknowledged by the network. For example, this may be based on expiry of BSR retransmission timer, and at least one logical channels contains UL data. This BSR type is referred to below to as ‘Regular BSR’. Periodic reporting of BSR may be, for example, upon expiry of a periodic BSR timer or period, the UE reports a ‘Periodic BSR’.

By employing these reporting formats and the associated MAC signalling, the scheduler can effectively utilize uplink buffer status reports to make informed decisions regarding QoS-aware packet scheduling. This enables the network to optimize resource allocation based on the buffer status of different logical channel groups, ensuring efficient, reliable, and QoS aware resource allocation.

When Regular BSR triggering events occur for multiple logical channels simultaneously, each logical channel may trigger one separate Regular BSR. It should be noted that BSRs are sent per LCG rather than per LCH, although it is possible for an LCG to include only a single LCH. In general, LCHs with similar priority are linked to the same LCG. This allows the network (e.g., node or gNB) to differentiate between the volume of high priority data and the volume of lower priority data.

As will be discussed in more detail below and elsewhere herein, according to some embodiments, a WTRU can report BSR (or PHR) to one or multiple cell groups in multi-connectivity as a function of the NES state of the cell groups. For example, if one node is in a NES state, the UE may transmit BSR (or PHR) on the cell groups not in an active NES state.

According to some embodiments, a WTRU may be configured with two or more cell groups (e.g. for multi-connectivity), where at least one cell group (e.g. one or more gNB(s)) can apply NES (e.g. an NES technique, such as cell DTX, DRX, turn off, or otherwise be in an NES state as defined elsewhere herein).

In some embodiments, the WTRU may receive and/or determine that a serving cell, cell group, or gNB is in an activated NES state. For example, in an embodiment, the WTRU may determine that one or more of the cell groups that it is configured with is in an active NES state.

According to some embodiments, the WTRU may be configured with an alternative (or different) reporting configuration for buffer status reporting (BSR) and/or power headroom reporting (PHR) during a NES state (e.g., this alternative configuration applies when a cell or cell group is in an NES state). For example, in an embodiment, the configuration for BSR and/or PHR during NES state may include one or more of: a pathloss threshold for triggering PHR, a prohibit timer for MAC CE transmission, and/or a periodic timer for triggering the MAC CE.

In some embodiments, for a triggered BSR on the MAC entity associated with a cell group in an active NES state, the WTRU does not trigger a scheduling request (SR) if the BSR is reported on the other cell group not in a NES state and/or if a SR is triggered for another MAC entity that is not in an active NES state. For example, according to certain embodiments, the WTRU may wait until the cell group in the active NES state is or will be transitioning to the non-NES state before transmitting BSR and/or SR.

According to some embodiments, the WTRU may apply the reporting configuration for BSR and/or PHR associated with a NES state for a given cell or cell group upon receiving an indication (or determining) that the associated cell (or cell group) is in a NES state.

In some embodiments, the WTRU may report BSR and/or PHR (e.g., the WTRU may transmit a BSR MAC CE and/or PHR MAC CE) to one or multiple cell groups in multi-connectivity as a function of NES state of the cell groups. For example, in an embodiment, the WTRU does not transmit and/or duplicate a BSR MAC CE to a cell group that is in a NES state, e.g., possibly as a function of the remaining time to the next on duration or NES state deactivation. For example, in an embodiment, the WTRU may report (e.g. transmit) a combined BSR MAC CE for BSRs triggered on cell groups that are in an active NES state to a cell group that is not in active NES state, if BSR is not transmitted to at least one cell group in a NES state.

According to some embodiments, the WTRU may trigger a new PHR if the PH (e.g. a virtual or estimated PH) for the cell group in an active NES state is above a threshold and the PH for the cell group not in an active NES state is below a threshold.

As a result, some example embodiments allow for timely reporting of channel or buffer conditions such that the scheduler will be able to use the reported scheduling information in a timely manner. In addition, certain example embodiments can avoid reporting stale channel or buffer conditions that will be useless to the scheduler by the time gNB, cell or cell group wakes up. Further, certain example embodiments provide a new PHR trigger that allows a gNB or cell (e.g., a cell or cell group in non-NES state) to deactivate cell DRX (or other NES technique) on the sleeping cell group (e.g., cell or cell group in an active NES state).

In some embodiments, a WTRU (e.g. WTRU 102 discussed above that includes circuitry, such as any of a processor, memory, transmitter and/or receiver) may receive configuration information (e.g. cell configuration information) for or indicating at least a first cell group and a second cell group. At least one of the first cell group and/or the second cell group are capable of applying NES techniques, as discussed elsewhere herein.

According to some embodiments, the WTRU may determine (or otherwise receive an indication) that at least the first cell group is in an active NES state.

In some embodiments, the WTRU may receive reporting configuration information associated with WTRU status reporting (e.g., BSR and/or PHR) during a NES state. For example, the status reporting may include or refer to buffer status reporting (BSR) and/or power headroom reporting (PHR), but may also include other types of reports associated with the WTRU status. In other words, the reporting configuration information may include or relate to performing (e.g. how to handle) BSR and/or PHR when a cell or cell group is an NES state.

According to some embodiments, the WTRU may apply the reporting configuration information associated with WTRU status reporting during the NES state for the first cell group that is in the active NES state.

In some embodiments, on condition that (or based on) the first cell group that is in the active NES state will be transitioning (or moving) from the active NES state to a non-active NES state (or non-NES state), the WTRU may trigger a medium access control (MAC) control element (CE) transmission associated with the WTRU status reporting.

According to some embodiments, to apply the reporting configuration information associated with status reporting during the network energy saving state for the cell group(s) that is/are in the active NES state, the WTRU may transmit any of a BSR and/or PHR, according to the reporting configuration information, based on the NES state of the cell group(s).

In some embodiments, the WTRU may be configured to transmit the BSR, based on the first cell group that is in the active NES state transitioning from the active NES state to the non-active NES state. For example, the WTRU may wait to transmit BSR until the cell group is or will be transitioning to the non-NES state.

According to some embodiments, the WTRU may be configured to transmit, to the second cell group that is not in an active NES state, a combined BSR for the first cell group (and any other cell group) that is in the active NES state.

In some embodiments, the WTRU may be configured to trigger a new PHR (e.g. in addition to a previously transmitted PHR), on condition that a PH associated with the first cell group that is in the active NES state is above a first configured threshold and a PH associated with the second cell group that is not in active NES state is below a second configured threshold.

According to some embodiments, the triggered MAC CE transmission may include any one or more of: a BSR MAC CE transmission, a SR MAC CE transmission, and/or a PHR MAC CE transmission.

In some embodiments, the reporting configuration information may include or indicate any one or more of: a pathloss threshold for triggering PHR, a prohibit timer for MAC CE transmission, and a periodic timer for triggering the MAC CE transmission.

According to some embodiments, the NES state may include any of cell discontinuous reception (DRX) and/or cell discontinuous transmission (DTX).

In some embodiments, the NES state is or may be considered activated on the first cell group (or another cell group) when or on condition that any of: a base station associated with the first cell group is in the NES state, all cells in the first cell group are in the NES state, and/or a primary cell in the first cell group is in the NES state.

As introduced above, some embodiments may relate or be directed to power headroom reporting (e.g. PHR MAC CEs) in multi-connectivity (MC) with NES.

In some embodiments, the WTRU may avoid triggering PHR based on a pathloss check and/or trigger (e.g. when pathloss is larger than a threshold), when the pathloss is associated with a reference signal of a TRP, cell or node that is in an active NES state and/or during the non-active period of a serving cell/TRP. The WTRU may condition triggering a PHR to conditions related to (e.g. only related to) TRPs that are not in an active NES state when in multi-connectivity. For example, the WTRU may trigger a PHR transmission if (e.g. only if) a triggering condition is met for a TRP, cell or node that is not in an active NES state (e.g. including pathloss, periodic, exposure, or retransmission triggers).

According to some embodiments, when a PHR is triggered, the WTRU may avoid reporting PHR for a sleeping node (e.g. a cell or TRP that is in an active NES state), if the time during which the PHR is triggered or transmitted falls within the non-active period of the sleeping node or x ms larger than the next availability period, e.g. if time until MAC CE reception is greater than a threshold (considering the reception time is the time during which the node is in an active availability period associated with a cell DTX pattern for example). In another example, the WTRU may avoid reporting PHR when any of the associated UL resources (e.g. subframes, slots, PUSCH occasions, antenna ports), including those that may be real or virtual resources, overlap with the durations (e.g. periods, slots, symbols) during which the cell, cell group or TRP may operate in a non-active state (e.g. the non-active period).

In some embodiments, the WTRU may change the format (e.g. type1, type2, type 3, single, multiple PHR, or padding PHR) of the reported PHR depending on the nodes that triggered and/or reported in the PHR that are not in an active NES state. For example, in dual connectivity, if one node is in an active NES state and another node is not, the WTRU may omit the octets associated with the node in NES state or switch to a single entry PHR format, even though the WTRU is in dual or multi-connectivity. The WTRU may select the PHR type (e.g. real, virtual) depending on the number of nodes reported that meet these criteria. The WTRU may consider PHR for a sleeping node in a NES state as a virtual node for the purpose of PHR reporting. In an example, when triggered to report PHR, the WTRU may determine the PH for the node that is in an NES state as a function of any of the path loss, UL resource size and max transmit power (e.g. Pcmax) values. Such values may be associated with the NES state of the node. For example, the WTRU may determine the max Tx power based on a minimum reserve power value that may be associated with the NES state of the node. Similarly, the WTRU may determine the UL resource size (e.g. PUSCH or SRS resource) based on any of a reference resource, configured and/or allocated resource and suspended resource (e.g. CG or SRS resource suspended during NES state). Such UL resource size values may be associated with the NES state of the node, for example.

According to some embodiments, for example when the WTRU is in multi-connectivity to a plurality of nodes (e.g. TRPs) and a subset or all TRPs are in a NES state, the WTRU may report PHR to a subset of TRPs (e.g. the WTRU may report PHR to one of the legs or both legs in dual connectivity), as a function of or based on one or more of: the NES state(s) of the involved nodes in the PHR report (e.g. for example, If one node is sleeping or in a NES state, the UE may need not to duplicate the PHR transmission to both MCG and SCG, possibly conditioned on having the PH above a threshold for the nodes that are not in a NES state); the nodes that have triggered PHR (e.g. if PH is low towards the MCG and a pathloss trigger is valid on the MCG, the UE can then report PH for both MCG and SCG and changes the format to e.g. type-2 PHR); the PHR type (e.g. real or virtual); and/or the PHR trigger type (e.g. pathloss, periodic, exposure, retransmission, etc.).

In some embodiments, the WTRU may change the pathloss change threshold used to trigger PHR or the pathloss reference source (e.g. signal) if the related node activates a NES state or in an active period of a cell DTX pattern. The WTRU may be configured with a different pathloss change threshold or a pathloss reference, which can be applied for PHR triggering when the associate node is in an active NES state. For example, the WTRU may switch to another pathloss reference once a node in multi-connectivity is in a NES state.

According to some embodiments, the WTRU may restart, pause, or stop the PHR prohibit timer or the PHR periodic trigger timer once the associated node is in an active NES state. The WTRU may apply an alternatively configured value for the prohibit timer or the PHR periodic trigger timer once the associated node is in an active NES state.

In some embodiments, the WTRU may be configured with an alternative configuration for status (e.g. PHR) reporting (that is applicable) during a NES state. For example, this configuration for PHR reporting include any one or more of: a pathloss threshold for triggering PHR, a prohibit timer for PHR MAC CE transmission, a periodic timer for triggering the PHR MAC CE. According to an embodiment, the WTRU may apply the PHR reporting configuration associated with a NES state for a given cell or cell group upon receiving an indication (or determining) that associated cell is NES state.

According to some embodiments, the WTRU may trigger a new PHR if a cell, cell group, and/or node is no longer in a NES state, has deactivated a NES state (e.g. upon reception of signaling indicating such deactivation), and/or within a period of time less than the next active period (e.g. upon/prior to an active period for cell DRX).

In some embodiments, when computing the power reservation and/or the output power for a node in multi-connectivity, the WTRU may forgoe reserving power for any node that is in a NES state or from which scheduling is not expected (e.g. during x ms following the PHR transmission, where x is configured, or during the non-active period associated with such NES node). In one example, in dual connectivity, the UE may assume that Pcmax is not adjusted (as if it is in single connectivity. For example, the UE may set its configured maximum output power PCMAX,f,c,MCG when the MCG is not in a NES state and the SCG in a NES state as total configured maximum output power for NR-DC operation P_{Total}^{NR-DC}, when the other node is in a NES state. The WTRU may not apply the configured inter-CG power sharing mode by NR-DC-PC-mode when one node is in a NES state, or may apply it only for nodes that are not in a NES state (from which it could be scheduled). The WTRU may be configured with alternative values for power reservation to apply in multi-connectivity when at least one other node is in a NES state or from which the WTRU is not expected to receive an uplink grant for transmission (e.g. during the non-active period). For example, the WTRU may apply an alternatively configured value for P_{CMAX,DC}, P_{EMAX,DC} or P_{NR} (e.g. P-NR, MCG or PN-NR,SCG) when the other node is in a NES state.

Some embodiments may include or be directed to PHR trigger(s) or wake-up signal(s) based on PH of the non-NES node (e.g. cell, cell group and/or TRP that is not in active NES state) and PH of the NES node (e.g. cell, cell group and/or TRP that is in an active NES state).

In some embodiments, the WTRU may trigger a multiple entry PHR (e.g. a type 2 PHR) that includes nodes that are sleeping or in a NES state if PH is less than a threshold (or pathloss is higher than a threshold) on one or more nodes that are not in a NES state and/or detecting that PH (e.g. virtual PH) is above threshold for at least one cell/TRP that is in an active NES state. Such can be helpful for the network to deactivate the NES state associated with other nodes that are reported. In one example, with dual connectivity, the WTRU may trigger a new PHR if the PH (e.g. virtual or estimated PH) for the cell group in an active NES state is above a threshold and the PH for the cell group not in an active NES state is below a threshold.

According to some embodiments, the WTRU may trigger a wake up signal transmission, a scheduling request, and/or transmit a wake up indication or associated assistance information if PH is less than a threshold (or pathloss is higher than a threshold) on one or more nodes that are not in a NES state and/or detecting that PH (e.g. virtual or estimated PHR) is above a threshold for at least one cell, cell group or TRP that is in an active NES state. The WTRU may trigger an SR on the node that is not in an active NES state to obtain a grant to transmit such indication should the WTRU not have an available grant to transmit the PHR (e.g. the type 2 PHR including the PH of the requested node). A wake up signal can be a preamble indication, an indication in msg3/msgA, or a PUSCH indication (e.g. UCI or MAC CE) that may indicate the indices of the nodes that are requesting to be woken up (or for which NES state is to be deactivated). This can be helpful for the network to deactivate the NES state associated with other nodes that are reported.

In some embodiments, the WTRU may start a response timer for monitoring a response from the network (e.g. form the connected node or the node in NES state) upon transmitting a wake up request or a PHR containing info on the node in NES state. The response timer may be associated with a random access response (RAR) or contention resolution timer if the RACH procedure is used, or associated with a PHR periodic or prohibit timer if the PHR procedure is used.

According to some embodiments, the WTRU may anticipate the deactivation of a NES state for the reported and/or requested node (e.g. a sleeping SN), e.g., following a PHR transmission on the node not in a NES state (e.g. the MN). The WTRU may monitor PDCCH on the requested node or other activation command coming from the sleeping node, possibly while the response timer is running. The UE may perform such PDCCH monitoring for an indication (e.g. in DCI) from the sleeping node in one or more search spaces or control resource sets possibly associated with the requested node or other sleeping nodes, possibly within a time duration/gap upon sending the PHR. The node that is not in a NES state (e.g. the MN) can inform the WTRU to start monitoring PDCCH on the SN (possible while a timer is running, e.g. a response timer). In some examples, the WTRU may receive the configuration information (e.g. SS/CORESET indexes, timing info) associated with the PDCCH monitoring on the SN from the MN.

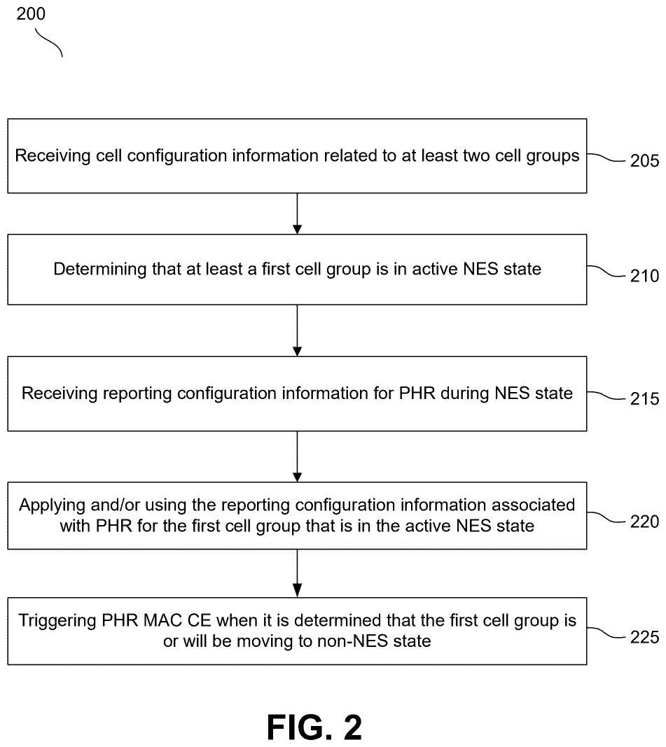

FIG. 2 illustrates an example flow diagram of a method 200 for or relating to reporting (e.g., PHR as introduced and discussed above), for example in multi-connectivity with NES, according to some example embodiments. The example method 200 of FIG. 2 and accompanying disclosures herein may include, may be based on, or may be a synthesization of various embodiments or elements discussed in detail above. For convenience and simplicity of exposition, the example of FIG. 2 may be described with reference to the architecture or system described above with respect to FIGS. 1A-1D, for instance. However, the example method 200 depicted in FIG. 2 may be carried out using different architectures as well. According to some embodiments, the method 200 of FIG. 2 may be implemented by a UE or WTRU, such as the WTRU 102 described in the foregoing.

It is noted that the method 200 of FIG. 2 may include further steps, procedures or details as discussed in detail elsewhere in this disclosure. As such, the method 200 of FIG. 2 may be modified to include any of the steps, procedures, elements and/or details illustrated and/or discussed in the foregoing. Moreover, it is noted that the method and/or blocks of FIG. 2 may be modified to include, or to be replaced by, any one or more of the procedures, elements or blocks discussed elsewhere herein. As such, one of ordinary skill in the art would understand that FIG. 2 is provided as one example and modifications thereto are possible while remaining within the scope of certain example embodiments.

As illustrated in the example of FIG. 2, the method 200 may include, at 205, receiving cell configuration information indicating at least first cell group and a second cell group (e.g. indicating a configuration associated with at least two cell groups, cells, nodes or the like). One or more of the cell groups are capable of applying (e.g. can apply) one or more NES techniques, as discussed elsewhere herein.

In an embodiment, the method 200 may include, at 210, determining that at least the first cell group is in an active NES state.

According to some embodiments, the method 200 may include, at 215, receiving reporting configuration information associated with power headroom reporting (PHR) during a NES state (e.g. receiving configuration information indicating information on how to handle PHR when a cell group, cell, node, etc. is in a NES state).

In some embodiments, the method 200 may include, at 220, applying and/or using the reporting configuration information associated with PHR during the NES state for the first cell group that is in the active NES state. For example, the applying and/or using at 220 may include triggering, sending or transmitting a PHR according to the reporting configuration information, based on the NES of the first cell group. Additionally or alternatively, the applying and/or using at 220 may include waiting to (or avoiding to) trigger, send and/or transmit the PHR according to the reporting configuration information, as discussed above.

According to some embodiments, the method 200 may include, at 225, on condition that the first cell group that is in the active NES state will be transitioning from the active NES state to a non-active NES state, triggering a medium access control (MAC) control element (CE) transmission associated with the PHR (e.g. a PHR MAC CE).

In some embodiments, the method 200 may include (not illustrated) sending the PHR when or after the first cell group transitions to the non-active NES state or the non-NES state.

According to certain embodiments, the method 200 may include (not illustrated) triggering a new PHR, on condition that a PH associated with the first cell group that is in the active NES state is above a first configured threshold and a PH associated with the second cell group that is not in an active NES state is below a second configured threshold.

In some embodiments, the reporting configuration information may include or indicate any one or more of: a pathloss threshold for triggering power headroom reporting, a prohibit timer for medium access control (MAC) control element (CE) transmission, and a periodic timer for triggering the medium access control (MAC) control element (CE) transmission.

According to some embodiments, the NES state may include any one or more of cell discontinuous reception (DRX), cell discontinuous transmission (DTX), a non-active period associated with cell DTX, or any other NES state or technique as discussed elsewhere herein.

In some embodiments, the NES state is or may be considered activated on the first cell group (or another cell group) when or based on any one or more of: a base station (e.g. one base station or more than one base station) associated with the first cell group is in the network energy saving state, all cells in the first cell group are in the network energy saving state, and/or a primary cell in the first cell group is in the network energy saving state.

Some embodiments may include or be directed to BSR reporting (e.g. BSR MAC CE transmission) in multi-connectivity with NES.

In some embodiments, the WTRU may be configured with two or more cell groups (e.g. for multi-connectivity), where at least one of the cell groups (e.g. network node or gNB) can apply (e.g. is capable of applying) NES. In certain embodiments, NES may refer to one or more NES techniques or methods, such as any of cell DTX, cell DRX, a non-active period associated with DTX or DRX, turning off, sleeping, or otherwise be in an NES state.

According to some embodiments, the UE may receive and/or determine that a cell group, serving cell, base station, network node or gNB is in an activated NES state (e.g. one or more of the at least one of the cell groups, network node or gNB that can apply NES is in an active NES state.

In some embodiments, the WTRU may be configured with a WTRU reporting configuration for BSR reporting during a NES state (e.g., an alternative configuration for use when the cell, cell group, node, or the like is in active NES state). For example, the WTRU reporting configuration may include any one or more of the following: a prohibit timer for BSR MAC CE transmission, and/or a periodic timer for triggering the BSR MAC CE. The WTRU may apply the WTRU reporting configuration for BSR associated with a NES state for a given cell or cell group upon receiving an indication (or determining) that associated cell is NES state.

In some embodiments, for a triggered BSR on the MAC entity associated with a cell group in an active NES state, the WTRU may not trigger an SR if the BSR is reported on the other cell group not in a NES state and/or if an SR is triggered for another MAC entity that is not in an active NES state. The WTRU may not trigger an SR or BSR if the MAC entity that triggered BSR is in an active NES state and/or if the time remaining until the next active period is larger than a threshold. In other words, according to certain embodiments, may trigger BSR (e.g., a MAC CE transmission) if the cell(s) or cell group(s) that is/are in the active network energy saving state will be transitioning from the active NES state to a non-active network energy saving state.

In view of the above, according to some embodiments, the WTRU may be configured to report BSR (or PHR) to one or multiple cell groups in multi-connectivity as a function of NES state of the cell groups. The WTRU may avoid (e.g. may not) transmit or duplicate a BSR MAC CE to a cell group that is in a NES state, possibly as a function of the remaining time to the next on duration or NES state deactivation.

Certain embodiments may relate to multi-MAC entity MAC CE reporting. In some embodiments, the WTRU may report a combined BSR MAC CE for BSRs triggered on cell groups that are in a NES state, e.g., if BSR is not transmitted to/for at least one cell group in a NES state. In some embodiments, the WTRU may omit the buffers status octet for other cell groups if the octet is a duplicate for another cell group. For example, the UE may include one bit/flag to indicate the buffer status is different for an LCG on a different cell group; otherwise, it can be assumed to be the same.

In some embodiments, the WTRU may report buffer status reports separately for each cell group in multi-connectivity, even for the cell groups in NES states or in a non-active duration, but the WTRU may transmit all buffer status reports/MAC CEs on the same cell group (cross-MAC entity MAC CE). If the transmission fails on one cell group, the WTRU may (re)-transmit the (combined) MAC CE(s) on a different cell group. The WTRU may prioritize the transmission on cell groups that are not in a NES state or for which the next availability period is the smallest.

According to some embodiments, if the WTRU knows the time until the next availability period/on duration for a given cell group (e.g. one that is in a NES state), the WTRU can determine whether to discard the MAC CE (e.g. BSR/PHR MAC CE). A new criteria can be used to determine whether to generate this MAC CE or not. For example, if a report is triggered (e.g. BSR/PHR) and a configured time period has elapsed, the WTRU discards/cancels the BSR/PHR and does not transmit the MAC CE. If the amount of buffered data changes more than a threshold, the WTRU can trigger a new BSR and/or recompute the MAC CE or discard/cancel the old one.

For split bearer, if the data volume is larger than the threshold, the WTRU may report it for both MAC entities in dual connectivity. If the UL data split threshold for a split bearer is set to infinity or above a given configured threshold, BSR MAC CE is never reported to a secondary cell group even during the cell DRX active period. Alternatively, if the UL data split threshold for a split bearer is below a given configured threshold, BSR MAC CE is not reported to a secondary cell group even during the cell DRX active period.

Some embodiments may be directed to or may include buffer status reporting and related aspects in MC with NES.

In some embodiments, a WTRU may be configured with different logical channel to logical channel group mapping, depending on the NES state of the cell group associated with the MAC. As one example, for non-NES operation, the network may configure the WTRU with 8 LCGs, while for NES operation 4 LCGs (e.g., only 4 LCGs) may be configured (however, it is noted that this is one example and a different number of LCGs may be configured according to other embodiments). This way, the size of the BSR report for the NES case will be reduced. In legacy NR, the logical channel configuration for each LCID contains a 1-to-1 mapping to a LCG. This can be extended to include a list of LCGs the LCID can be associated with, depending on the NES state of the cell group (e.g., LCIDs n1, n2 associated with LCG g1, LCIDs n3 and n4 associated with LCG g2, etc. for non NES operation of the cell group, but LCIDs n1, n2, n3, n4 all associated with LCG g1 for NES operation). Further grouping and/or differentiation could be made depending on the type of the NES state of the cell group (e.g. DTX, spatial power reduction, etc.). The WTRU, upon determining that the NES state of the cell group has changed, will re-apply the LCID to LCG mapping associated with the new NES state, and then proceed as in legacy when it comes to BSR reporting.

According to some embodiments, when the MAC entity (e.g. cell/cell group) is in an active NES state, BSR triggering may be conditioned on having data arrival from a subset of LCHs that can trigger BSR while the associated cell group is in a NES state.

In some embodiments, specific types of BSR reports may be prioritized when operating under DC and NES state operation. In an example, periodic BSR may be allowed (e.g. may only be allowed) for non-NES state cell groups, whereas NES state cell groups may utilize only regular BSR reports. The NES state cell groups may utilize NES state indication from network to disable periodic BSR reports (e.g., by temporarily disabling/freezing the ‘periodicBSR-Timer’). In an embodiment, periodic BSR reports may be disabled/suspended when gNB transitions to an NES state. The gNB may indicate to WTRUs (e.g. in ‘RRC_connected’ state) of upcoming NES state transition, the WTRUs may use this as an indication to suspend and/or reset ‘periodicBSR-Timer’, in order delay sending additional BSR reports until it receives a subsequent indication of NES state ending wherein it may then resume the ‘periodicBSR-Timer’. Alternately, different periodic BSR timer values may be configured for NES state operation wherein upon receiving indication of imminent transition to NES state, the UE suspends (legacy) ‘periodicBSR-Timer’, and switches to a an (NES specific) ‘periodicBSR-Timer’. Whether periodic BSR is used or not, or different periodicities are applied, according to any of the embodiments discussed above, may also be dependent on the type of the NES state. For example, different periodicities may be configured for different types of NES states of the cell group (e.g., DTX, spatial power reduction, etc.).

Additionally, according to some embodiments, there may be restrictions or additional triggers for certain BSR reports under NES state operation. For example, a BSR report may be triggered with usual timer operation (e.g., based on expiration of ‘retxBSR-timer’) and data (LCG class). For example, if the LCG is a high priority group/class, and additionally based on NES state related information such as time since last BSR (for this NES cell group and/or the non-NES cell group), time until the cell group moves back to non-NES state, etc.

In certain embodiments, BSR in NES state may be limited to just short BSR reports even in the case where there is more than one LCG at UE buffer, where the WTRU may select one of the LCG groups for which to provide the BSR. The choice of which LCG to select may be based on the change or delta in buffer data volume from previous BSR report, whether a higher priority LCG traffic has arrived while in NES state, time remaining until gNB transitions back to non-NES state, absolute or relative volume of data per LCG, whether BSR was triggered for cell group which is not in NES state, etc. Additionally, the WTRU may switch between short and long BSR for a particular cell group that is in NES state based on any of the criteria described herein.

In some embodiments, the WTRU may rely on purely padding BSR (e.g., switch from regular/periodic BSR to padding BSR reports) to limit unnecessary or wasteful BSR reports when cell group's NES state change is imminent. Additionally, in certain embodiments, padding BSR can be limited to support short BSR only, wherein data volume in buffer and/or priority of LCG as well additional criteria described herein may be utilized to select the LCG if padding only allows for short/truncated BSR.

In some embodiments, the WTRU may be configured to apply different behavior regarding the sending of an SR in case a BSR is triggered and no UL resources are available for sending the BSR. For example, the UE may be configured to not send an SR in case the cell group was in an NES state (i.e., BSR will be sent the next time an UL grant becomes available). For example, in certain embodiments, the WTRU may be configured to wait until the cell group is leaving the (active) NES state and/or is entering (e.g. will be transitioning) to the non-NES state (e.g. non-active NES state).

In some embodiments, when the WTRU is configured with one or more SR configurations, an indication may be provided for each SR configuration. According to an embodiment, the indication may be provided whether that configuration is applicable when the cell group is in an NES state or not. For example, only a subset of the SR configurations may be application for the NES operation. Alternatively, there could be some SR configurations that are applicable only for NES operation.

In some embodiments, for a given SR configuration, there could be different parameters associated with NES state or non NES state. For example, for a given SR configuration, there could be two values for the status prohibit timer (sr-ProhibitTimer), maximum number of SR transmission (sr-TransMax), etc. (e.g. one value corresponding to non-NES operation and another one for NES operation). Alternatively, one (e.g., only one) value per parameter may be provided as in legacy, but the UE may be configured with a scaling factor or delta value that it will use to derive the values to use for the NES state (e.g., multiply/divide the parameter value by the scaling factor, add/subtract the delta value from the parameter value, etc.).

If the WTRU is configured to apply different parameters for a given SR configuration depending on the NES state, the WTRU may further be configured to reset the SR_COUNTER of the corresponding SR configuration to 0 upon detecting an NES change and applying the different values. In another example, the WTRU may not reset the counter value. In another example, the WTRU may reset the counter value to 0 upon detecting the cell group switching from NES state to non NES state, but not when switching from non NES state to NES state. In another example, the WTRU may reset the counter value to 0 upon detecting a switching of the cell group from non NES state to NES state, but not when switching from NES state ton non NES state.

A logical channel configuration may include a logicalChannelSR-DelayTimerApplied information element. If this is set to true, it indicates whether to apply the delay timer for SR transmission for this logical channel (i.e., an SR that is to sent due to a BSR that was triggered due to data belonging to the logical).

In some embodiments, the WTRU may be configured to apply different SR delaying mechanisms for the NES and non-NES operation. For example, for a given logical channel (or for all logical channels, or for logical channels within a given LCG, etc. ,) the WTRU may be configured to apply SR delaying only when it is operating in NES state. Alternatively, the WTRU may apply different delay timer values (e.g., logicalChannelSR-DelayTimer IE specified in the BSR config), one for the non-NES state, and another for NES state. Alternatively, a scaling factor or delta values may be provided to determine the NES state SR delay timer values from the non NES state ones.

In NR, the IE BSR-config that is part of the MAC Cell group configuration includes configuration for the perdiocBSR-Timer, retxBSR-Timer and SR-DelayTimer.

In some embodiments, the WTRU may be configured with more than one BSR-Config, each corresponding to different types of NES states (e.g., one for cell DTX, one for spatial power reduction, etc.). Alternatively, there could be just one BSR-config that is to be used for all NES states.

In some embodiments, the WTRU may have just one BSR-config as in legacy, but it may contain multiple sets of values for the different timers, each corresponding to the different NES states. Alternatively, scaling factors or delta values may be included for each NES state, to be applied on determining the values to use for the NES operation. There could be different scaling factors or delta values for each timer value, or there could just one scaling factor or delta value for all timer values. There could also be different scaling factors or delta values for a given NES state, or the same value can be used for all NES state (i.e., no differentiation among the different types of NES).

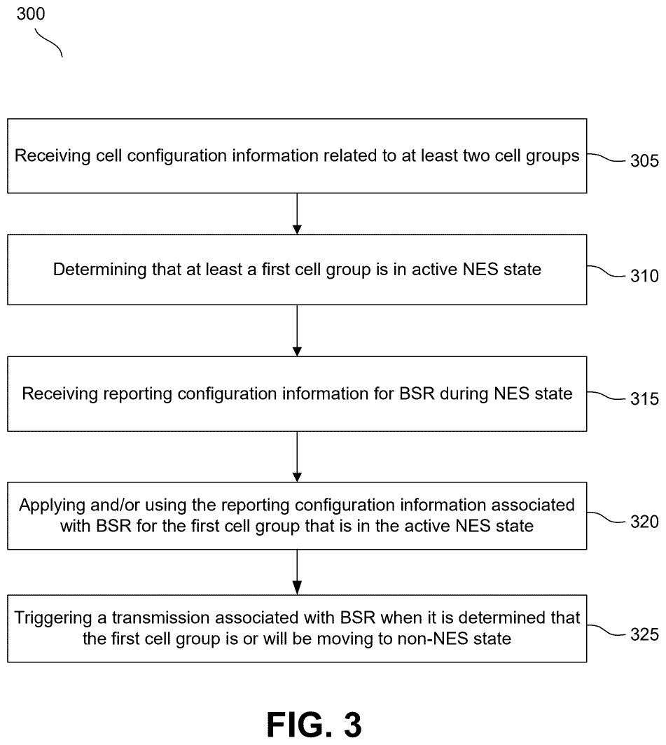

FIG. 3 illustrates an example flow diagram of a method 300 for or relating to reporting (e.g., BSR as introduced and discussed above), for example in multi-connectivity with NES, according to some example embodiments. The example method 300 of FIG. 3 and accompanying disclosures herein may include, may be based on, or may be a synthesization of various embodiments or elements discussed in detail above. For convenience and simplicity of exposition, the example of FIG. 3 may be described with reference to the architecture or system described above with respect to FIGS. 1A-1D, for instance. However, the example method 300 depicted in FIG. 3 may be carried out using different architectures as well. According to some embodiments, the method 300 of FIG. 3 may be implemented by a UE or WTRU, such as the WTRU 102 described in the foregoing.

It is noted that the method 300 of FIG. 3 may include further steps, procedures or details as discussed in detail elsewhere in this disclosure. As such, the method 300 of FIG. 3 may be modified to include any of the steps, procedures, elements and/or details illustrated and/or discussed in the foregoing. Moreover, it is noted that the method and/or blocks of FIG. 3 may be modified to include, or to be replaced by, any one or more of the procedures, elements or blocks discussed elsewhere herein. As such, one of ordinary skill in the art would understand that FIG. 3 is provided as one example and modifications thereto are possible while remaining within the scope of certain example embodiments.

As illustrated in the example of FIG. 3, the method 300 may include, at 305, receiving cell configuration information indicating at least first cell group and a second cell group (e.g. indicating a configuration associated with at least two cell groups, cells, nodes or the like). One or more of the cell groups are capable of applying (e.g. can apply) one or more NES techniques, as discussed elsewhere herein.

In an embodiment, the method 300 may include, at 310, determining that at least the first cell group is in an active NES state.

According to some embodiments, the method 300 may include, at 315, receiving reporting configuration information associated with BSR during a NES state (e.g. receiving configuration information indicating information on how to handle BSR when a cell group, cell, node, etc. is in a NES state).

In some embodiments, the method 300 may include, at 320, applying and/or using the reporting configuration information associated with BSR during the NES state for the first cell group that is in the active NES state. For example, the applying and/or using at 320 may include triggering, sending or transmitting a BSR according to the reporting configuration information, based on the NES of the first cell group. Additionally or alternatively, the applying and/or using at 320 may include waiting to (or avoiding to) trigger, send and/or transmit the BSR according to the reporting configuration information, as discussed above.

According to some embodiments, the method 300 may include, at 325, on condition that the first cell group that is in the active NES state will be transitioning from the active NES state to a non-active network energy saving state (e.g. when it is determined that the cell group is or will be moving to the non-NES state), triggering a transmission associated with the BSR. For example, the triggered transmission may include a BSR medium access control (MAC) control element (CE) transmission and/or a scheduling request (SR).

In some embodiments, the method 300 may include (not illustrated) sending the BSR based on the first cell group transitioning (e.g. when or after the first cell group transitions) to the non-active NES state (or the non-NES state). For example, the BSR may be sent when (e.g. only when) the WTRU determines that the cell group is or is going to be moving to a non-NES state, as discussed elsewhere herein.

According to some embodiments, a combined BSR for at least the first cell group (and possibly another cell group) that is in the active NES state may be sent to the second (or other) cell group that is not in an active NES state.

In some embodiments, the reporting configuration information may include or indicate any one or more of: a pathloss threshold for triggering power headroom reporting, a prohibit timer for medium access control (MAC) control element (CE) transmission, and a periodic timer for triggering the medium access control (MAC) control element (CE) transmission.

According to some embodiments, the NES state may include any one or more of cell discontinuous reception (DRX), cell discontinuous transmission (DTX), a non-active period associated with cell DTX, or any other NES state or technique as discussed elsewhere herein.

In some embodiments, the NES state is or may be considered activated on the first cell group (or another cell group) when or based on any one or more of: a base station (e.g. one base station or more than one base station) associated with the first cell group is in the network energy saving state, all cells in the first cell group are in the network energy saving state, and/or a primary cell in the first cell group is in the network energy saving state.

Most of the description provided above discusses whether to apply different parameters or behaviors for NES state as compared to a non-NES state. It should be noted that the behavior or parameters for all NES states could be the same or further differentiation could be made for the different types of NES states (e.g. one set of parameters or scaling factors provided for each type of NES state).

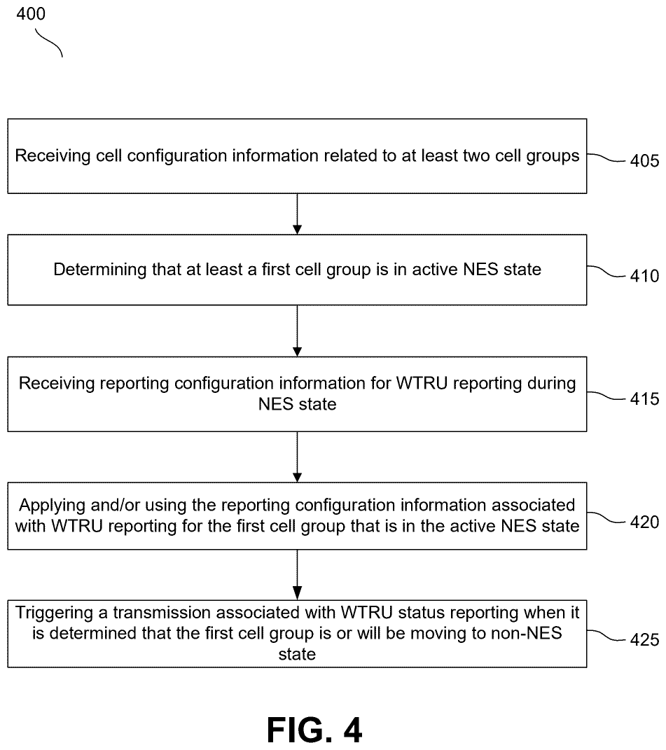

FIG. 4 illustrates another example flow diagram of a method 400 for or relating to reporting (e.g., BSR and/or PHR as introduced and discussed above), for example in multi-connectivity with NES, according to some example embodiments. The example method 400 of FIG. 4 and accompanying disclosures herein may include, may be based on, or may be a synthesization of various embodiments or elements discussed in detail above. For convenience and simplicity of exposition, the example of FIG. 4 may be described with reference to the architecture or system described above with respect to FIGS. 1A-1D, for instance. However, the example method 400 depicted in FIG. 4 may be carried out using different architectures as well. According to some embodiments, the method 400 of FIG. 4 may be implemented by a UE or WTRU, such as the WTRU 102 described in the foregoing.

It is noted that the method 400 of FIG. 4 may include further steps, procedures or details as discussed in detail elsewhere in this disclosure. As such, the method 400 of FIG. 4 may be modified to include any of the steps, procedures, elements and/or details illustrated and/or discussed in the foregoing. Moreover, it is noted that the method and/or blocks of FIG. 4 may be modified to include, or to be replaced by, any one or more of the procedures, elements or blocks discussed elsewhere herein. As such, one of ordinary skill in the art would understand that FIG. 4 is provided as one example and modifications thereto are possible while remaining within the scope of certain example embodiments.

As illustrated in the example of FIG. 4, the method 400 may include, at 405, receiving cell configuration information indicating at least a first cell group and a second cell group (e.g. indicating a configuration associated with at least two cell groups, cells, nodes or the like). One or more of the cell groups (e.g. at least one of the first and second cell groups) are capable of applying (e.g. can apply) one or more NES techniques, as discussed elsewhere herein.

In an embodiment, the method 400 may include, at 310, determining that at least the first cell group is in an active NES state.

According to some embodiments, the method 400 may include, at 415, receiving reporting configuration information associated with WTRU reporting during a NES state (e.g. receiving configuration information indicating information on how to handle WTRU reporting when a cell group, cell, node, etc. is in a NES state).

In some embodiments, the method 400 may include, at 420, applying and/or using the reporting configuration information associated with WTRU reporting during the NES state for the first cell group that is in the active NES state.

For example, the applying and/or using at 420 may include triggering, sending or transmitting a transmission associated with WTRU reporting according to the reporting configuration information, based on the NES state of the first cell group. Additionally or alternatively, the applying and/or using at 420 may include waiting to (or avoiding to) trigger, send and/or transmit the transmission associated with WTRU reporting according to the reporting configuration information, as discussed above.

According to some embodiments, the WTRU status reporting may include BSR and/or PHR, and/or the like.

According to some embodiments, the method 400 may include, at 425, on condition that the first cell group that is in the active NES state will be transitioning from the active NES state to a non-active network energy saving state (e.g. when it is determined that the cell group is or will be moving to the non-NES state), triggering a transmission (e.g., medium access control (MAC) control element (CE) transmission) associated with the WTRU status reporting. For example, the triggered transmission may include a BSR MAC CE, PHR MAC CE, and/or a scheduling request (SR), or the like.

In some embodiments, the method 400 may include (not illustrated) sending WTRU reporting, such as a PHR and/or BSR, based on the first cell group transitioning (e.g. when or after the first cell group moves or enters) to the non-active NES state (or the non-NES state). For example, the WTRU reporting (e.g. BSR and/or PHR) may be sent when (e.g. only when) the WTRU determines that the cell group is or is going to be moving to a non-NES state, as discussed elsewhere herein.

In some embodiments, the reporting configuration information may include or indicate any one or more of: a pathloss threshold for triggering power headroom reporting, a prohibit timer for medium access control (MAC) control element (CE) transmission, and a periodic timer for triggering the medium access control (MAC) control element (CE) transmission.

According to some embodiments, the method may include (not illustrated) transmitting, to the second cell group that is not in an active NES state, a combined BSR for the first cell group (and possibly another cell group) that is in the active NES state.

In some embodiments, the method may include (not illustrated) triggering a new PHR (e.g. a second or subsequent PHR), on condition that a PH associated with the first cell group that is in the active NES state is above a first configured threshold and a PH associated with the second cell group that is not in active NES state is below a second configured threshold.

According to some embodiments, the NES state may include any one or more of cell discontinuous reception (DRX), cell discontinuous transmission (DTX), a non-active period associated with cell DTX, or any other NES state or technique as discussed elsewhere herein.

In some embodiments, the NES state is or may be considered activated on the first cell group (or another cell group) when or based on any one or more of: a base station (e.g. one base station or more than one base station) associated with the first cell group is in the network energy saving state, all cells in the first cell group are in the network energy saving state, and/or a primary cell in the first cell group is in the network energy saving state.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for”is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

### REFERENCES

The following references may have been referred to hereinabove, each of which is incorporated herein by reference in its entirety.
TR 38.864, “Study on network energy savings for NR (Release 18)”, v 18.0.0;
RP-234065, “New WID: Network energy savings for NR”, Ericsson;
TR 38.840, Study on UE power savings, v 16.0.0;
TS 38.321, v 18.0.0;
TS 38.213, v 18.1.0.

1. A wireless transmit/receive unit (WTRU), comprising:
circuitry, including any of a processor, memory, transmitter and receiver, the circuitry configured to
receive cell configuration information indicating a first cell group and a second cell group, wherein at least one of the first cell group and the second cell group are capable of applying one or more network energy saving techniques;
determine that at least the first cell group is in an active network energy saving state;
receive reporting configuration information associated with WTRU status reporting during a network energy saving state;
apply the reporting configuration information associated with WTRU status reporting during the network energy saving state for the first cell group that is in the active network energy saving state; and
on condition that the first cell group that is in the active network energy saving state will be transitioning from the active network energy saving state to a non-active network energy saving state, trigger a medium access control (MAC) control element (CE) transmission associated with WTRU status reporting.

2. The WTRU of claim 1, wherein the WTRU status reporting comprises any of power headroom reporting and buffer status reporting.

3. The WTRU of claim 1, wherein, to apply the reporting configuration information associated with WTRU status reporting during the network energy saving state for the first cell group that is in the active network energy saving state, the circuitry is configured to: transmit any of a power headroom report and buffer status report, according to the reporting configuration information, based on the network energy saving state of the first cell group.

4. The WTRU of claim 3, wherein the circuitry is configured to transmit the buffer status report, based on the first cell group that is in the active network energy saving state transitioning from the active network energy saving state to the non-active network energy saving state.

5. The WTRU of claim 3, wherein the circuitry is configured to transmit, to the second cell group that is not in an active network energy saving state, a combined buffer status report for the first cell group that is in the active network energy saving state.

6. The WTRU of claim 2, wherein the circuitry is configured to trigger a new power headroom reporting, on condition that a power headroom associated with the first cell group that is in the active network energy saving state is above a first configured threshold and a power headroom associated with the second cell group that is not in active network energy saving state is below a second configured threshold.

7. The WTRU of claim 1, wherein the triggered MAC CE transmission comprises any of: a buffer status reporting MAC CE transmission, a scheduling request, and a power headroom reporting MAC CE transmission.

8. The WTRU of claim 1, wherein the reporting configuration information indicates any of: a pathloss threshold for triggering power headroom reporting, a prohibit timer for medium access control (MAC) control element (CE) transmission, and a periodic timer for triggering the medium access control (MAC) control element (CE) transmission.

9. The WTRU of claim 1, wherein the network energy saving state comprises any of cell discontinuous reception (DRX), cell discontinuous transmission (DTX), or the non-active period associated with cell DTX.

10. The WTRU of claim 1, wherein the network energy saving state is activated on the first cell group when any of: a base station associated with the first cell group is in the network energy saving state, all cells in the first cell group are in the network energy saving state, and a primary cell in the first cell group is in the network energy saving state.

11. A method, implemented by a wireless transmit/receive unit (WTRU), the method comprising:
receiving cell configuration information indicating a first cell group and a second cell group, wherein at least one of the first cell group and the second cell group are capable of applying one or more network energy saving techniques;
determining that at least the first cell group is in an active network energy saving state;
receiving reporting configuration information associated with WTRU status reporting during a network energy saving state;
applying the reporting configuration information associated with WTRU status reporting during the network energy saving state for the first cell group that is in the active network energy saving state; and
on condition that the first cell group that is in the active network energy saving state will be transitioning from the active network energy saving state to a non-active network energy saving state, triggering a medium access control (MAC) control element (CE) transmission associated with WTRU status reporting.

12. The method of claim 11, wherein the WTRU status reporting comprises any of power headroom reporting and buffer status reporting.

13. The method of claim 11, wherein applying the reporting configuration information associated with WTRU status reporting comprises transmitting any of a power headroom report and buffer status report, according to the reporting configuration information, based on the network energy saving state of the first cell group.

14. The method of claim 13, comprising transmitting the buffer status report, based on the first cell group that is in the active network energy saving state transitioning from the active network energy saving state to the non-active network energy saving state.

15. The method of claim 13, comprising transmitting, to the second cell group that is not in an active network energy saving state, a combined buffer status report for at least the first cell group that is in the active network energy saving state.

16. The method of claim 12, comprising triggering a new power headroom reporting, on condition that a power headroom associated with the first cell group that is in the active network energy saving state is above a first configured threshold and a power headroom associated with the second cell group that is not in active network energy saving state is below a second configured threshold.

17. The method 11, wherein the triggered MAC CE transmission comprises any of: a buffer status reporting MAC CE transmission, a scheduling request, and a power headroom reporting MAC CE transmission.

18. The method of claim 11, wherein the reporting configuration information indicates any of: a pathloss threshold for triggering power headroom reporting, a prohibit timer for medium access control (MAC) control element (CE) transmission, and a periodic timer for triggering the medium access control (MAC) control element (CE) transmission.

19. The method of claim 11, wherein the network energy saving state comprises any of cell discontinuous reception (DRX), cell discontinuous transmission (DTX), or the non-active period associated with cell DTX.

20. The method of claim 11, wherein the network energy saving state is activated on the first cell group when any of: a base station associated with the first cell group is in the network energy saving state, all cells in the first cell group are in the network energy saving state, and a primary cell in the first cell group is in the network energy saving state.
